(19) United States
(12) Patent Application Publication
(10) Pub. No.: US 2016/0353776 A1
(43) Pub. Date: Dec. 8, 2016

(54) METHOD FOR PREPARING BACON

(71) Applicant: ARMOR INOX, Mauron (FR)

(72) Inventors: Bernard CADORET, MAURON (FR); Olivier MARQUET, MAURON (FR)

(73) Assignee: ARMOR INOX, Mauron (FR)

(21) Appl. No.: 15/170,064

(22) Filed: Jun. 1, 2016

(30) Foreign Application Priority Data
Jun. 5, 2015 (FR) 15/55140

(51) Int. Cl. A21C 9/06

(52) U.S. Cl. CPC A23L 1/3103; A23L 1/0073; A23L 1/01; A23V 2002/00

(57) ABSTRACT

A method for preparing bacon may include: a provision step for providing an impervious film; an initial deposition step where at least one rind, having on one of its faces a variable thickness of fat, is spread on the film; a first deposition step where a first layer of pork meat is spread on the variable thickness of fat of the rind, thus forming an assembly; a packaging step during which the assembly is enclosed under vacuum in the impervious film forming a sealed pouch; a pressing step where the sealed pouch is disposed in a mould and compressed; a cooking step where the sealed pouch is cooked in the mould; a cooling step where the sealed pouch is cooled in the mould; a step of removal from the mould, where the sealed pouch is discharged from the mould; and an unpouching step, where the sealed pouch is removed.

### TECHNICAL FIELD

The invention relates to a method for preparing bacon.

### BACKGROUND

Currently, the industrial preparation of bacon consists of, using a full belly of pork, injecting it with brine, suspending said belly on supports standing on rails, and then heating and smoking said belly thus suspended, cooling it and providing maturation of the belly at negative temperature in order to ensure good cohesion of the lean and fat parts of the belly. The belly is next placed in a press, which shapes it in order to obtain a belly having a substantially parallelepipidal form. The belly thus conformed is next sliced and packaged.

Although such a method is satisfactory from the taste point of view, it is not from the industrial point of view because of certain cost imperatives with regard to certain ranges of product. This is because the belly is heat-treated without being protected, which causes evaporation of water from the belly and significant loss of weight. This belly moreover consists of a complete muscle with great dimensional variability related to the anatomy of the animal, complicating cooking, forming and slicing. There are losses at the start and end of slicing and, as the initial length of the pork belly is limited to the size of the pig from which it comes, these losses are reproduced with each belly and are therefore relatively great. The preparation method is also highly manual and difficult to automate, Furthermore there are often separate technological steps for the cooking and smoking of the products.

### SUMMARY

One object of the present invention is therefore to propose a method for preparing bacon that does not have the drawbacks of the prior art and which in particular requires less manual manipulation.

To this end, a method for preparing bacon is proposed, comprising:
a provision step during which an impervious film is provided,
an initial deposition step during which at least one rind, having on one of its faces a variable thickness of fat, is spread on said film,
a first deposition step during which a first layer of pork meat is spread on the variable thickness of fat of the rind, thus forming an assembly,
a packaging step during which the assembly is enclosed under vacuum in the impervious film forming a sealed pouch,
a pressing step during which the sealed pouch is disposed in a mould and compressed,
a cooking step during which the sealed pouch is cooked in the mould,
a cooling step during which the sealed pouch is cooled in the mould,
a step of removal from the mould, during which the sealed pouch is discharged from the mould, and
an unpouching step, during which the sealed pouch is removed.

The invention also proposes a method for preparing bacon comprising:
an initial deposition step during which at least one rind, having a variable thickness of fat on one of its faces, is spread,
a first deposition step during which a first layer of pork meat s spread over the variable thickness of fat of the rind, thus forming an assembly,
a provision step during which an impervious film is provided,
a final deposition step during which the assembly is deposited on the impervious film,
a packaging step during which the assembly is enclosed under vacuum in the impervious film forming a sealed pouch,
a pressing step during which the sealed pouch is disposed in a mould and compressed,
a cooking step during which the sealed pouch is cooked in the mould,
a cooling step during which the sealed pouch is cooled in the mould,
step of removal from the mould during which the sealed pouch is discharged from the mould, and
an unpouching step during which the sealed pouch is removed.

Advantageously, the preparation method comprises, between the first deposition step and the packaging step, a first additional deposition step during which a layer of pork fat is spread on the first layer of pork meat, and a second additional deposition step during which a second layer of pork meat is spread on the layer of pork fat, and the assembly is formed from the rind, the first layer of pork meat, the layer of pork fat and the second layer of pork meat.

Advantageously, the preparation method comprises, between the first deposition step and the provision step, a first additional deposition step during which a layer of pork fat is spread on the first layer of pork meat, and a second additional deposition. step during which a second layer of pork meat is spread on the layer of pork fat, and the assembly is formed from the rind, the first layer of pork meat, the layer of pork fat and the second layer of pork meat.

Advantageously, the provision step consists of providing an impervious film comprising a bottom conformed so as to take the form of a vessel and a lid, and the packaging step consists of depositing the lid on the base and sealing it under vacuum.

Advantageously, the provision step consists of providing an impervious film in the form of an impervious sheet, and the packaging step consists of folding the impervious sheet in order to receive the assembly and sealing its edges after putting under vacuum.

Advantageously, prior to the deposition steps, the pork meat and the pork fat are destructured until a homogeneous fluid product is obtained, and the deposition steps are performed by an apportioning pump.

Advantageously, the deposition steps are performed by an apportioning pump having a first nozzle depositing the first layer of pork meat, a second nozzle depositing the layer of pork fat, and a third nozzle depositing the second layer of pork meat, each nozzle having a width equal to the width of the assembly, the three nozzles are disposed behind one another in the longitudinal direction of the assembly, the nozzles are driven in a translation movement with respect to the rind in a translation direction parallel to the longitudinal direction of the assembly, the first nozzle is the furthest forward with respect to the direction of the translation, the third nozzle is the most rearward with respect to the direction of the translation, and the second nozzle is intermediate between the first nozzle and the second nozzle.

### BRIEF DESCRIPTION OF THE DRAWINGS

The features of the invention mentioned above, as well as others, will emerge more clearly from a reading of the following description of an example embodiment, said description being given in relation to the accompanying drawings, among, which:

FIG. 1 shows a flow diagram of the preparation method according to a first embodiment of the invention,

FIG. 2 shows a flow diagram of a preparation method according to a second embodiment of the invention,

FIG. 3 shows a particular step of the method according to the first embodiment,

FIG. 4 shows a particular step according to one of the embodiments, and

FIG. 5 shows another particular step of the method,

### DETAILED DESCRIPTION

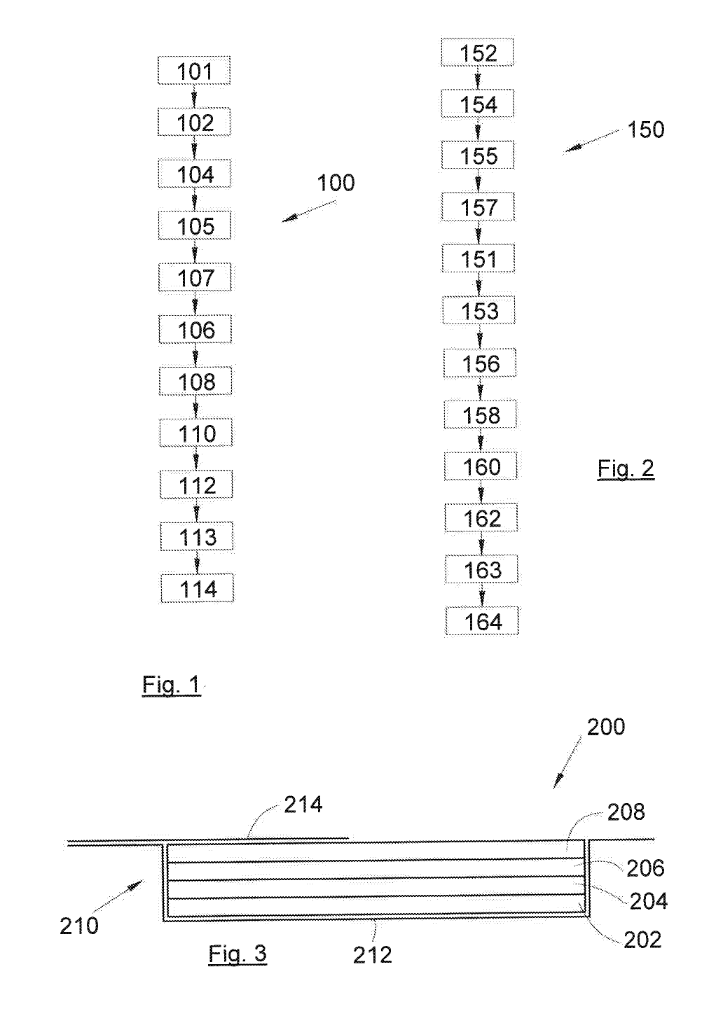

FIG. 1 shows a method 100 for preparing bacon.

The preparation method 100 comprises:
a provision step 101 during which an impervious film is provided,
an initial deposition step 102 during which at least one rind, having on one of its faces a variable thickness of fat, is spread on said film,
a first deposition step 104 during which a first layer of pork meat is spread on the variable thickness of fat of the rind, thus forming an assembly,
a packaging step 106 during which the assembly is enclosed under vacuum in the impervious film forming a sealed pouch, which makes it possible to ensure cohesion of the layers together during cooking,
a pressing step 108 during which the sealed pouch is disposed in a mould and compressed,
a cooking step 110 during which the sealed pouch is cooked in the mould, in particular at a temperature of approximately 50° C. if it is wished to obtain a partially cooked product and 70° C. in order to obtain a cooked product,
a cooling step 112 during which the sealed pouch is cooled in the mould, in particular at a temperature of approximately 5° C. at the core,
a step 113 of removal from the mould, during which the sealed pouch is discharged from the mould, and
an unpouching step 114, during which the scaled pouch is removed.

FIG. 2 shows a method 150 for preparing bacon.

The preparation method 150 comprises:
an initial deposition step 152 during which at least one rind, having a variable thickness of fat on one of its faces, is spread,
a first deposition step 154 during which a first layer of pork meat is spread over the variable thickness of fat of the rind, thus forming an assembly, a provision step 151 during which an impervious film is provided,
a final deposition step 153 during which the assembly is deposited on the impervious film,
a packaging step 156 during which assembly is enclosed under vacuum in the impervious film forming a sealed pouch, which makes it possible to ensure cohesion of the layers together during cooking,
a pressing step 158 during which the sealed pouch is disposed in a mould and compressed,
a cooking step 160 during which the sealed pouch is cooked in the mould, in particular at a temperature of approximately 50° C. if it is wished to obtain a partially cooked product and 70° C. in order to obtain a cooked product,
a cooling step 162 during which the sealed pouch is cooled in the mould, in particular at a temperature of approximately 5° C. at the core,
a step 163 of removal from the mould during which the sealed pouch is discharged from the mould, and
an unpouching step 164 during which the sealed pouch is removed.

Following the unpouching steps 114, 164, the bacon thus produced is maintained at negative temperature until it reaches a core temperature of approximately 3° C. and is then sliced and packaged in order to be consumed.

The two preparation methods present two alternatives to the same problem, namely the automated preparation of bacon.

The preparation methods 100 and 150 therefore make it possible to avoid the significant manual manipulations since the meat is packaged and can therefore be manipulated by suitable machines, in particular by conveyor belts. The loss of water is also restricted because of the presence of the sealed pouch.

The placing of the various layers in a closed sealed pouch makes it possible to dispose several rinds one after the other, and thus to obtain a longer assembly, for example 1500 mm, limiting accordingly the losses at the start and end of slicing, It is also not necessary to press the bacon bars after freezing, these having been pressed continuously during the cooking and cooling step. It can also be envisaged using previously destructured, injected and churned pieces of meat in order to develop similar products.

According to the characteristics of the bacon to be obtained, the preparation method 100 according to the first embodiment may comprise, between the first deposition step 104 and the packaging step 106, a first additional deposition step 105 during which a layer of pork fat is spread on the first layer of pork meat, and a second additional deposition step 107 during which a second layer of pork meat is spread on the layer of pork fat. The assembly then consists of the rind, the first layer of pork meat, the layer of pork fat and the second layer of pork meat.

In the same way, the preparation method 150 according to the second embodiment may comprise, between the first deposition step 154 and the provision step 151, a first additional deposition step 155 during which a layer of pork fat is spread on the first layer of pork meat, and a second additional deposition step 157 during which a second layer of pork meat is spread on the layer of pork fat. The assembly then consists of the rind, the first layer of pork meat, the layer of pork fat and the second layer of pork meat.

The pork fat comes for example from the subcutaneous layer of the pig and it is optionally destructured by means of a chopper or a cutter. A functional ingredient gelling cold or an extract of proteins affording cohesion after cooking and cooling may be added.

The impervious film is produced for example from a polyamidepolyethylene complex.

The various steps of deposition of pork meat 104, 154, 107 and 157, and pork fat 105, 155, may be performed manually or automatically.

In the latter case, prior to the deposition steps 104, 154, 105, 155, 107 and 157, the pork meat and the pork fat are destructured, that is to say divided into elements of small dimensions and then injected with brine and mixed, until a homogeneous and sufficiently fluid product is obtained. The deposition steps 104, 154, 105, 155, 107 and 157 are then performed by an apportioning pump provided with a deposition nozzle that deposits the pork meat and the pork fat.

The mould used takes in particular the form of a parallelepipedal vessel with a lid closing the vessel, After the filled sealed pouch is placed in the vessel, the lid presses the sealed pouch so that it adopts the form of the vessel and the various layers forming the assembly are compressed against one another. It is also possible to position two superimposed sealed pouches in the same mould.

FIGS. 3 to 5 presents an assembly 200 that comprises at least one rind 202, a first layer of pork meat 204, a layer of pork fat 206, and a second layer of pork meat 208. In another embodiment, the layer of pork fat 206 and the second layer of pork meat 208 may be absent.

FIG. 3 show an example in the context of the first embodiment when the impervious film 210 comprises a base 212 and a lid 214. The base 212 is conformed so as to adopt the form of a vessel in which the assembly 200 is formed gradually, that is to say the initial deposition step 102 and the various deposition steps 104, 105 and 107 are performed by deposition on the base 212. The provision step 101 then consists of providing the base 212 and the lid 214, During the packaging step 106, the lid 214 is deposited and sealed on the base 212 in order to close it after previously having effected the vacuum inside the assembly consisting of the base 212 and its lid 214 so as to eliminate the air. In FIG. 3, the lid 214 is shown partially open.

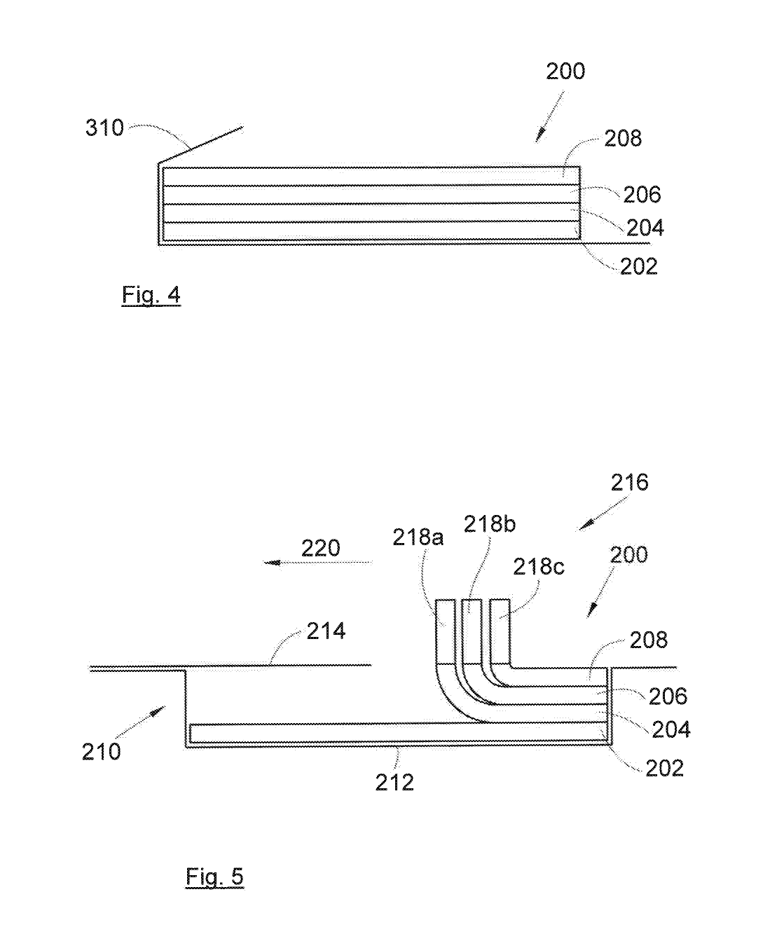

FIG. 4 shows an example in the context of the first embodiment or of the second embodiment. The impervious film 310 consists of a foldable sheet on which the assembly 200 is produced gradually (first embodiment) or deposited after production thereof (second embodiment). The provision step 101, 151 then consists of providing the impervious sheet 310. During the packaging step 106, 156, the impervious sheet 310 is folded so as to cover the assembly 200 and its edges are sealed after putting under vacuum. In FIG. 4, the sheet 310 is shown partially folded.

FIG. 5 presents a particular embodiment in which a head 216 of an apportioning pump has three deposition nozzles 218a-c. There is thus one nozzle 218a-c for each layer of pork meat 204, 208 or layer of pork fat 206 to be deposited.

Each nozzle 218a-c is connected through a pusher to a reservoir in which the pork meat 204, 208 or the pork fat 206 to be deposited is stored. Naturally, if the two layers of pork meat 204 and 208 are identical in composition, the two reservoirs corresponding to these two pork meats 204 and 208 may constitute the same reservoir. Thus the pork meat 204, 208 or the pork fat 206 stored in a reservoir is pushed by the pusher towards the nozzle 218a-c through which it flows in order to form the assembly 200.

Each nozzle 218a-c has a width equal to the width of the assembly 200 and the three nozzles 218a-c are disposed behind one another in the longitudinal direction of the assembly 200. The nozzles 218a-c are driven in a translation movement (arrow 220) with respect to the rind 202. The direction of the translation is parallel to the longitudinal direction of the assembly 200. The first nozzle 218a furthest towards the front with respect to the direction of the translation 220 deposits the first layer of pork meat 204, the third nozzle 218c furthest towards the rear with respect to the translation direction 220 deposits the second layer of pork meat 208, and the second nozzle 218b intermediate between the first nozzle 218a and the third nozzle 218e deposits the layer of pork fat 206.

Such a head 216 therefore makes it possible to produce the assembly 200 in a single pass.

The translation of the nozzles 218a-c with respect to the rind 202 can be achieved by moving the nozzles 218a-c or by moving the rind 202.

FIG. 5 is applied to the first embodiment of the invention in the case of an impervious film 210 comprising a base 212 and a lid 214, but may be applied in the same way to the first embodiment in the case of an impervious sheet 310, or to the second embodiment.

Where there is only one layer of pork meat 204 on the rind 202, the head has a single nozzle spreading the pork meat 204 on the rind 202.

To transfer the colour and a smoked taste to the bacon, it is possible to use an impervious film impregnated with suitable products, or to pass the bacon through an infrared oven after the unpouching step.

In another embodiment, it is also possible not to implement the initial deposition step 102 and therefore to obtain bacon without rind.

1. A method for preparing bacon, comprising:
a provision step during which an impervious film is provided,
an initial deposition step during which at least one rind, having on one of its faces a variable thickness of fat, is spread on said film,
a first deposition step during which a first layer of pork meat is spread on the variable thickness of fat of the rind, thus forming an assembly,
a packaging step during which the assembly is enclosed under vacuum in the impervious film forming a sealed pouch,
a pressing step during which the sealed pouch is disposed in a mould and compressed,
a cooking step during which the sealed pouch is cooked in the mould,
a cooling step during which the sealed pouch is cooled in the mould,
a step of removal from the mould, during which the sealed pouch is discharged from the mould, and
an unpouching step, during which the sealed pouch is removed.

2. A method for preparing bacon, comprising:
an initial deposition step during which at least one rind, having a variable thickness of fat on one of its faces, is spread,
a first deposition step during which a first layer of pork meat is spread over the variable thickness of fat of the rind, thus forming an assembly,
a provision step during which an impervious film is provided,
a final deposition step during which the assembly is deposited on the impervious film,
a packaging step during which assembly is enclosed under vacuum in the impervious film forming a sealed pouch,
a pressing step during which the sealed pouch is disposed in a mould and compressed,
a cooking step during which the sealed pouch is cooked in the mould,
a cooling step during which the sealed pouch is cooled in the mould,
a step of removal from the mould during which the sealed pouch is discharged from the mould, and
an unpouching step during which the sealed pouch is removed.

3. The method according to claim 1, further comprising, between the first deposition step and the packaging step, a first additional deposition step during which a layer of pork fat is spread on the first layer of pork meat, and a second additional deposition step during which a second layer of pork meat is spread on the layer of pork fat, and in wherein the assembly is formed from the rind, the first layer of pork meat, the layer of pork fat and the second layer of pork meat.

4. The method according to claim 2, further comprising, between the first deposition step and the provision step, a first additional deposition step during which a layer of pork fat is spread on the first layer of pork meat, and a second additional deposition step during which a second layer of pork meat is spread on the layer of pork fat, and wherein the assembly is formed from the rind, the first layer of pork meat, the layer of pork fat and the second layer of pork meat.

5. The method according to claim 1, wherein the provision step consists of providing an impervious film comprising a bottom conformed so as to take the form of a vessel and a lid, and wherein the packaging step consists of depositing the lid on the base and sealing it under vacuum.

6. The method according to claim 1, wherein the provision step consists of providing an impervious film in the form of an impervious sheet, and wherein the packaging step consists of folding the impervious sheet in order to cover the assembly and to seal its edges after putting under vacuum.

7. The method according to claim 1, wherein, prior to the deposition steps, the pork meat and the pork fat are destructured until a homogeneous fluid product is obtained, and wherein the deposition steps are performed by an apportioning pump.

8. The method according to claim 7, wherein the deposition steps are performed by an apportioning pump having a first nozzle depositing the first layer of pork meat, a second nozzle depositing the layer of pork fat, and a third nozzle depositing the second layer of pork meat, wherein each nozzle has a width equal to the width of the assembly, wherein the three nozzles are disposed behind one another in the longitudinal direction of the assembly, wherein the nozzles are driven in a translation movement with respect to the rind in a translation direction parallel to the longitudinal direction of the assembly, the first nozzle is the furthest forward with respect to the direction of the translation, wherein the third nozzle is the most rearward with respect to the direction of the translation, and wherein the second nozzle is intermediate between the first nozzle and the second nozzle.

9. The preparation method according to claim 2, wherein the provision step consists of providing an impervious film comprising a bottom conformed so as to take the form of a vessel and a lid, and in that the packaging step consists of depositing the lid on the base and sealing it under vacuum.

10. The preparation method according to claim 2, wherein the provision step consists of providing an impervious film in the form of an impervious sheet, and wherein the packaging step consists of folding the impervious sheet in order to cover the assembly and to seal its edges after putting under vacuum.

11. The preparation method according to claim 2, wherein, prior to the deposition steps, the pork meat and the pork fat are destructured until a homogeneous fluid product is obtained, and wherein the deposition steps are performed by an apportioning pump.
